(19) United States
(12) Patent Application Publication
(10) Pub. No.: US 2025/0005244 A1
(43) Pub. Date: Jan. 2, 2025

(54) TIMING CONSTRAINT AUTO-CREATION FOR INTEGRATED CIRCUIT TESTING

(71) Applicant: INTERNATIONAL BUSINESS MACHINES CORPORATION, ARMONK, NY (US)

(72) Inventors: ERIC FOREMAN, FAIRFAX, VT (US); JACK DILULLO, AUSTIN, TX (US); NATHAN BUCK, UNDERHILL, VT (US); MICHAEL HEMSLEY WOOD, WILMINGTON, DE (US); ROBERT JOHN ALLEN, JERICHO, VT (US); HEMLATA GUPTA, HOPEWELL JUNCTION, NY (US); NATESAN VENKATESWARAN, HOPEWELL JUNCTION, NY (US); KERIM KALAFALA, RHINEBECK, NY (US)

(21) Appl. No.: 18/342,183

(22) Filed: Jun. 27, 2023

(51) Int. Cl. G06F 30/3315; G06F 30/333

(52) U.S. Cl. CPC G06F 30/3315; G06F 30/333

(57) ABSTRACT

Timing constraint auto-creation for integrated circuit testing includes analyzing an integrated circuit design using a first clocking attribute, wherein the first clocking attribute describes a first clock for the integrated circuit design; identifying, based on the analysis and the first clocking attribute, design features of the integrated circuit design necessitating timing constraints; and generating, based on the identified design features, the timing constraints for the static timing analysis of the integrated circuit design.

### BACKGROUND

### Field of the Disclosure

The field of the disclosure is data processing, or, more specifically, methods, apparatus, and products for performing timing constraint auto-creation for integrated circuit testing.

### Description of Related Art

Fabrication of an integrated circuit or chip includes several steps to finalize such as logic design, analysis, and physical implementation. The chip may be designed according to a hierarchical design methodology such that the chip is divided into functional circuit components or elements. The logic design and component placement must result in a physical implementation that meets the design and performance requirements of the chip. To ensure that the design requirements are met, design analysis such as timing analysis of the chip is performed at different stages and levels of design.

### SUMMARY

Exemplary embodiments include a method, apparatus, and computer program product to perform timing constraint auto-creation for integrated circuit testing. A method according to an embodiment includes analyzing an integrated circuit design using a first clocking attribute, wherein the first clocking attribute describes a first clock for the integrated circuit design; identifying, based on the analysis and the first clocking attribute, design features of the integrated circuit design necessitating timing constraints; and generating, based on the identified design features, the timing constraints for the static timing analysis of the integrated circuit design.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows a block diagram of an example computing system configured for performing timing constraint auto-creation for integrated circuit testing in accordance with embodiments of the present disclosure.

FIG. 2 shows a block diagram of a system configured for performing timing constraint auto-creation for integrated circuit testing in accordance with embodiments of the present disclosure.

FIG. 3 is a flowchart of an example method for performing timing constraint auto-creation for integrated circuit testing according to some embodiments of the present disclosure.

FIG. 4 is a flowchart of an example method for performing timing constraint auto-creation for integrated circuit testing according to some embodiments of the present disclosure.

### DETAILED DESCRIPTION

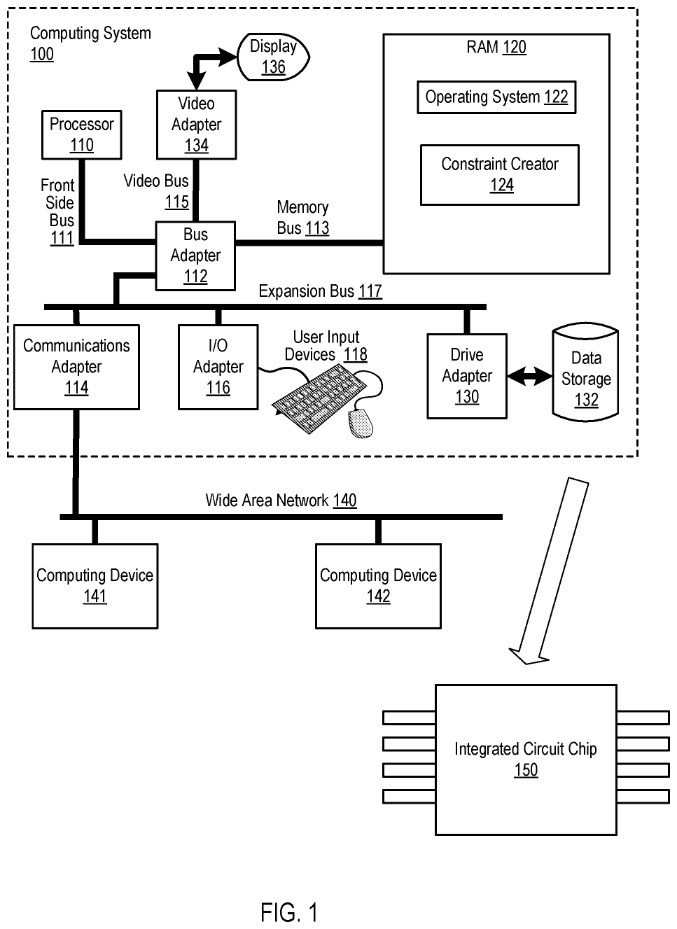

Exemplary apparatus and systems for performing timing constraint auto-creation for integrated circuit testing in accordance with the present disclosure are described with reference to the accompanying drawings, beginning with FIG. 1. FIG. 1 sets forth a block diagram of automated computing machinery comprising an exemplary computing system 100 configured for performing timing constraint auto-creation for integrated circuit testing according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for performing timing constraint auto-creation for integrated circuit testing according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is constraint creator 124, including for designing digital integrated circuits such as an integrated circuit chip 150 and performing timing constraint auto-creation for integrated circuit testing according to embodiments of the present disclosure.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (′I/O′) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

As previously discussed, design analysis such as timing analysis is performed to ensure that the physical implementation of a chip design will meet requirements. For example, static timing analysis is generally performed to efficiently accomplish timing analysis without simulating the full integrated circuit. In static timing analysis, one or more timing signals are propagated through the simulated chip design from an input side to a timing point and timing values of interest are computed such as arrival time, slew, and slack. Different timing values may be associated with different clock types of the integrated circuit such as test clocks vs. functional clocks. Static timing analysis is performed at different stages of the design, but analyzing the entire chip design at every stage is inefficient in terms of run-time. Instead, a hierarchical design methodology is used and timing analysis is performed at different hierarchical levels (e.g., core, unit, component) based on the needs at any given design stage.

A component of the chip may be, for example, a single logic gate or a collection of circuits configured to perform a specific task or function. Detailed analysis may be formed at the component level. For example, components may be timed using accurate timing analysis techniques that include transistor level timing tools or gate level timing tools. This type of detailed analysis may be followed by generation of abstract models that represent the relevant characteristics, such as timing characteristics, of the component in a simplified form. The generation of abstract models may be referred to as abstraction. At higher levels (e.g., unit level, core level), components are represented by abstracts for the purposes of performing the analysis. A unit comprised of several components, each associated with abstracts, may itself be abstracted. Because components are reused in different parts of the chip design at different levels of hierarchy, the same component may be part of different clock domains.

Some timing points or nodes may be associated with timing constraints. A timing constraint refers to a modification or other control exerted based on the incoming timing signal. An exemplary timing constraint is the adjustment of the arrival time at a node by a specified value, based on the incoming signal being a functional signal. While executing a static timing analysis procedure including propagating timing values from an input side to an output side of an integrated circuit, a timing constraint may specify modifying the timing at a node with the constraint, at a node toward the output side from the node with the constraint, or at a node toward the input side from the node with the constraint. In some situations, some constraints may be in the form of loops between components.

In order to achieve proper coverage and margining in timing analysis, static timing analysis involves the creation of a plurality of clock phases for each of several generalizable categories such as functional and test categories. Examples of such generalizable categories include functional, scan, automatic built in self-test (ABIST), array test, and multiple frequencies on the same chip. To achieve correct timing at circuit components such as latches, local clock buffers (LCBs), and other complex circuitry, timing constraints are added which control/adjust the propagation of timing phases based on these generalizable characteristics. For example, at a particular latch input, a timing engineer may need to “don't care” all timing phases of a scan type while retaining all functional phases.

In traditional timing analysis, such timing constraints need to be explicitly written against each phase belonging to a generalizable category. It should be noted that the number of phases that can correspond to a generalizable category may be dozens or more. This traditional timing analysis approach introduces significant complexity and associated runtime and memory cost. Many clocks of different types catering to various timing requirements may be defined in a timing analysis run. Often, in order to assert a timing constraint (such as a value adjustment) common to all clocks of a particular type, the same adjustment assertion needs to be applied for every functional clock defined in the system. The number of assertions on a timing point is the same as the number of clocks in a given clock type. Any new clock addition to the existing clock type requires assertions to be applied for the newly created clock. If later in the flow another clock is defined for an existing clock type, in traditional timing analysis the newly defined clock does not receive the correct assertion. It is often difficult to recognize missing assertions and looking at the assertions applied in a traditional timing run does not clearly state the intent of the assertion, and intent is lost among these plurality of assertions.

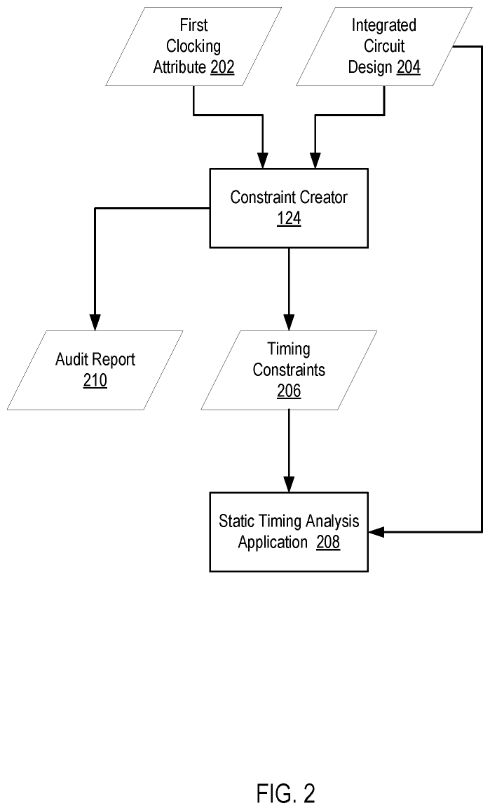

FIG. 2 shows a block diagram of a timing constraint auto-creation for integrated circuit testing in accordance with embodiments of the present disclosure. As shown in FIG. 2, the system includes the constraint creator 124 and a static timing analysis application 208. The constraint creator 124 receives a first clocking attribute 202 and an integrated circuit design 204 and generates the timing constraints 206 and an audit report 210. The timing constraints 206 are then provided to the static timing analysis application 208 which performs the static timing analysis using the timing constraints 206 and the integrated circuit design 204. The constraint creator 124 and the static timing analysis application 208 may be executing on the same computing system or may be part of separate computing systems (e.g., a constraint creator computing system and a static timing analysis application computing system).

The constraint creator 206 is hardware, software, or an aggregation of hardware and software that creates timing constraints 206 for the static timing analysis of the integrated circuit design 204. Specifically, the constraint creator 206 uses the first clocking attribute 202 and the integrated circuit design 204 to create, in-core during run, phase commands, auto-corner scaling, user define adjusts, clock groups, noise exclusions, and other necessary parameter files. The integrated circuit design 204 is data describing the topology of an integrated circuit, including the connections between the elements. The integrated circuit design may be a netlist. The first clocking attribute 202 is data describing a clock for the integrated circuit design 204. Specifically, the first clocking attribute 202 is a clock definition and may describe an absolute clock speed or a clock speed relative to another clock. The first clocking attribute 202 may be a seed clock.

As described above, timing constraints 206 are data describing a modification or other control exerted based on the incoming timing signal. Timing constraints include commands called during the static timing analysis run that specify, for example, an arrival time, a transition time, an adjust, or other timing quantity. Timing constraints are required to realistically simulate the operating conditions of an integrated circuit. The audit report 210 is a record of the timing constraints created by the constraint creator 124.

The static timing analysis application 208 is hardware, software, or an aggregation of hardware and software that executes a static timing analysis on the integrated circuit design 204 using the timing constraints 206. The static timing analysis application 208 simulates portions of the integrated circuit described by the integrated circuit design 204 to determine the existence of timing violations. The static timing analysis application 208 requires the integrated circuit design 204 along with the timing constraints 206 to generate accurate results.

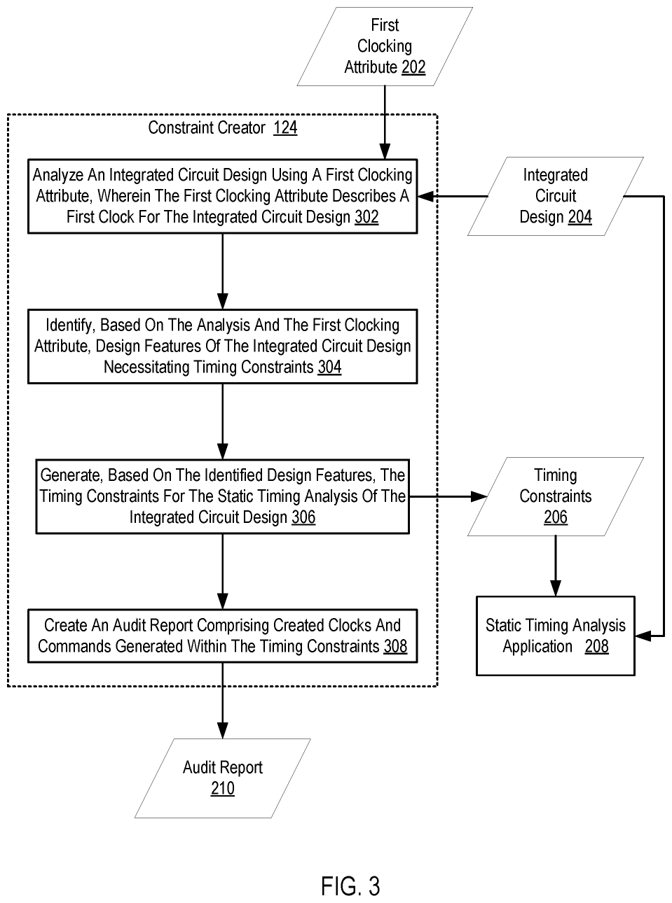

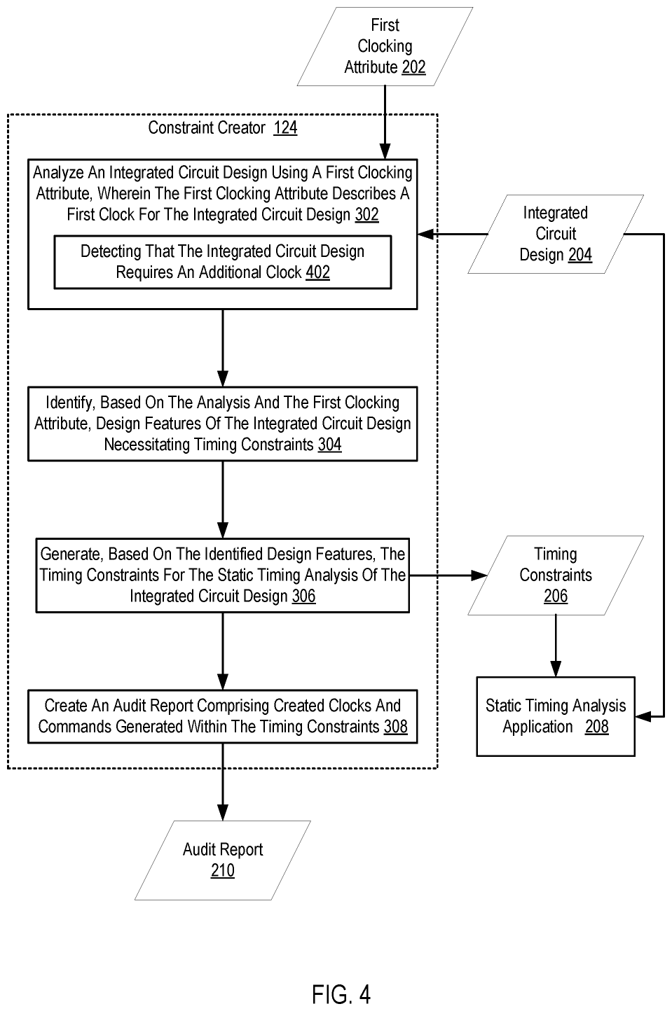

For further explanation, FIG. 3 sets forth a flowchart of an example method for performing timing constraint auto-creation for integrated circuit testing according to some embodiments of the present disclosure. In a particular embodiment, the method of FIG. 4 is performed utilizing the constraint creator 124. The method of FIG. 3 includes analyzing 302 an integrated circuit design 204 using a first clocking attribute 202, wherein the first clocking attribute 202 describes a first clock for the integrated circuit design 204. Analyzing 302 an integrated circuit design 204 using a first clocking attribute 202 may be carried out by generating one or more clocks from the clocking attribute 202 and applying the one or more clocks to different portions of the integrated circuit design 204.

The first clocking attribute 202 may include an absolute clock speed or a relative clock speed. Across different portions of the integrated circuit design 204, different clocks may require generation based on the design features of that portion of the integrated circuit design 204. Accordingly, different clocks may be generated from the first clocking attribute 202 based on the particular design features. The first clocking attribute 202 may include, for example, a clock divider, a half-cycle margin, a grid crossing, or a phase pair exclusion. The first clocking attribute 202 may be received via user input (e.g., within a parameter file provided to the constraint creator 124).

The constraint creator 124 may receive more than one clock attribute for the analysis. For example, a second clocking attribute may be received and used to create one or more additional clocks for analysis of the integrated circuit design 204. The second clocking attribute may be defined in terms relative to the first clocking attribute 202, such as one-half the frequency of the first clocking attribute 202. Analyzing 302 the integrated circuit design 204 using the first clocking attribute 202 may include receiving additional parameters. Such additional parameters may include, for example, instructions to create additional clocks, instructions to add a half-cycle margin, instructions to add a grid-crossing margin, and instructions to add a phase pair exclusions.

The method of FIG. 3 further includes identifying 304, based on the analysis and the first clocking attribute 202, design features of the integrated circuit design 204 necessitating timing constraints 206. Identifying 304, based on the analysis and the first clocking attribute 202, design features of the integrated circuit design 204 necessitating timing constraints 206 may be carried out by detecting that a particular design feature will result in an inaccurate simulation of the integrated circuit design without the application of a timing constraint. Detecting the particular design feature may be carried out by matching the design features to at least one timing constraint. Specifically, the constraint creator 124 may utilize an index of design features keyed to timing constraints. If the constraint creator 124 detects that the integrated circuit design 204 includes a design feature with an entry in the index, then that design feature is identified as necessitating a timing constraint. Examples of design features include clock pins, clock domains, voltage domains, and groupings of domains.

The method of FIG. 3 further includes generating 306, based on the identified design features, the timing constraints 206 for the static timing analysis of the integrated circuit design 204. Generating 306, based on the identified design features, the timing constraints 206 for the static timing analysis of the integrated circuit design 204 may be carried out by retrieving the timing constraints keyed to the identified design features and modifying those timing constraints based on the specific features of the integrated circuit design 204. Generating 306, based on the identified design features, the timing constraints 206 for the static timing analysis of the integrated circuit design 204 may further be carried out by creating the timing phase tags, adjustments, and other clock commands for use during the static timing analysis. Generating 306 the timing constraints 206 may also include generating a log of each element of the generated timing constraints 206. Following the generation of the timing constraints 206 for the static timing analysis, the static timing analysis may be executed on the integrated circuit design using the timing constraints. Specifically, the static timing analysis may then be performed by the static timing analysis application 208 executing the clock commands and other commands during the static timing analysis.

The method of FIG. 3 further includes creating 308 an audit report 210 comprising created clocks and commands generated within the timing constraints 206. Creating 308 the audit report 210 comprising the created clocks and commands generated within the timing constraints 206 may be carried out by accessing the log created by the constraint creator 124 during the generation of the timing constraints 206. The log entries may then be used to populate the audit report 210. The audit report 210 may include, for example, a listing of clocks created, listing of the user define adjust commands created, and a listing of the exclude commands created. The audit report 210 may be used by a designer to debug an issue with the integrated circuit design 204 or static timing analysis.

The constraint creator 124 may also expose a set of application programming interface commands to provide data about the timing constraints to other applications. Specifically, the constraint creator 124 exposes the log or other parameter files to other applications such that the applications can request specific data from the constraint creator 124 (or object created by the constraint creator 124). For example, an application performing a power analysis on the integrated circuit design 204 may request the frequency of particular clocks at particular locations within the integrated circuit design 204. The constraint creator 124 (or object created by the constraint creator 124) can provide the specified information in response to the request.

For further explanation, FIG. 4 sets forth a flow chart illustrating a further exemplary method for timing constraint auto-creation for integrated circuit testing according to embodiments of the present invention that includes analyzing 302 an integrated circuit design 204 using a first clocking attribute 202, wherein the first clocking attribute 202 describes a first clock for the integrated circuit design 204; identifying 304, based on the analysis and the first clocking attribute 202, design features of the integrated circuit design 204 necessitating timing constraints 206; generating 306, based on the identified design features, the timing constraints 206 for the static timing analysis of the integrated circuit design 204; and creating 308 an audit report 210 comprising created clocks and commands generated within the timing constraints 206.

The method of FIG. 4 differs from the method of FIG. 3, however, in that analyzing 302 an integrated circuit design 204 using a first clocking attribute 202 includes detecting 402 that the integrated circuit design 204 requires an additional clock. Detecting 402 that the integrated circuit design 204 requires an additional clock may be carried out by the constraint creator 124 inspecting the design features and determining that the design intent for a design feature necessitates the creation of an additional clock. For example, the integrated circuit design 204 may include design features for an ABIST. If the constraint creator 124 detects an ABIST design feature, the constraint creator 124 will create the necessary clock. Once the additional clock is created, the same process proceeds to identifying, based on the analysis and the additional clock, design features of the integrated circuit design 204 necessitating timing constraints 206 and generating 306, based on the identified design features, the timing constraints 206 for the static timing analysis of the integrated circuit design 204.

In view of the explanations set forth above, readers will recognize that the benefits of performing timing constraint auto-creation for integrated circuit testing according to embodiments of the present disclosure include:
Reduces complexity of creating timing constraints by automatically generating the timing constraints based on the design features of the integrated circuit design.
Reduces time required to create timing constraints by automatically generating the timing constraints based on the design features of the integrated circuit design.
Removes potential human error of creating timing constraints by automatically generating the timing constraints based on the design features of the integrated circuit design.

Exemplary embodiments of the present disclosure are described largely in the context of a fully functional computer system for performing timing constraint auto-creation for integrated circuit testing. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for timing constraint auto-creation for static timing analysis, the method comprising:
analyzing an integrated circuit design using a first clocking attribute, wherein the first clocking attribute describes a first clock for the integrated circuit design;
identifying, based on the analysis and the first clocking attribute, design features of the integrated circuit design necessitating timing constraints; and
generating, based on the identified design features, the timing constraints for the static timing analysis of the integrated circuit design.

2. The method of claim 1, further comprising:
executing the static timing analysis on the integrated circuit design using the timing constraints.

3. The method of claim 1, further comprising:
creating an audit report comprising created clocks and commands generated within the timing constraints.

4. The method of claim 1, wherein analyzing the integrated circuit design using a first clocking attribute further uses a second clocking attribute.

5. The method of claim 1, wherein analyzing the integrated circuit design using a first clocking attribute comprises detecting that the integrated circuit design requires an additional clock.

6. The method of claim 1, wherein identifying, based on the analysis and the first clocking attribute, design features of the integrated circuit design necessitating timing constraints comprises matching the design features to at least one timing constraint.

7. The method of claim 1, wherein the first clocking attribute includes one selected from a group consisting of a clock divider, a half-cycle margin, a grid crossing, and a phase pair exclusion.

8. The method of claim 1, wherein the timing constraints comprise timing phase tags and adjustments.

9. The method of claim 1, wherein the first clocking attribute is a seed clock.

10. The method of claim 1, wherein the first clocking attribute is received via user input.

11. An apparatus for timing constraint auto-creation for static timing analysis, the apparatus comprising:
a computer processor; and
a computer memory operatively coupled to the computer processor, the computer memory having disposed within it computer program instructions that, when executed by the computer processor, cause the apparatus to:
analyze an integrated circuit design using a first clocking attribute, wherein the first clocking attribute describes a first clock for the integrated circuit design;
identify, based on the analysis and the first clocking attribute, design features of the integrated circuit design necessitating timing constraints; and
generate, based on the identified design features, the timing constraints for the static timing analysis of the integrated circuit design.

12. The apparatus of claim 11, wherein the computer program instructions further cause the apparatus to:
executing the static timing analysis on the integrated circuit design using the timing constraints.

13. The apparatus of claim 11, wherein the computer program instructions further cause the apparatus to:
create an audit report comprising created clocks and commands generated within the timing constraints.

14. The apparatus of claim 11, wherein analyzing the integrated circuit design using a first clocking attribute further uses a second clocking attribute.

15. The apparatus of claim 11, wherein analyzing the integrated circuit design using a first clocking attribute comprises detecting that the integrated circuit design requires an additional clock.

16. The apparatus of claim 11, wherein identifying, based on the analysis and the first clocking attribute, design features of the integrated circuit design necessitating timing constraints matching the design features to at least one timing constraint.

17. The apparatus of claim 11, wherein the first clocking attribute includes one selected from a group consisting of a clock divider, a half-cycle margin, a grid crossing, and a phase pair exclusion.

18. The apparatus of claim 11, wherein the timing constraints comprise timing phase tags and adjustments.

19. The apparatus of claim 11, wherein the first clocking attribute is a seed clock.

20. A computer program product for timing constraint auto-creation for static timing analysis, the computer program product disposed upon a computer readable medium, the computer program product comprising computer program instructions that, when executed, cause a computer to:
analyze an integrated circuit design using a first clocking attribute, wherein the first clocking attribute describes a first clock for the integrated circuit design;
identify, based on the analysis and the first clocking attribute, design features of the integrated circuit design necessitating timing constraints; and
generate, based on the identified design features, the timing constraints for the static timing analysis of the integrated circuit design.
